(19) United States
(12) Patent Application Publication
(10) Pub. No.: US 2007/0152585 A1
(43) Pub. Date: Jul. 5, 2007

(54) Plasma display panel

(76) Inventors: Hyo-Suk Lee, Suwon-si (KR); Tae-Woong Jang, Suwon-si (KR); Jae-Hyung Kim, Suwon-si (KR); Bong-Kyoung Park, Suwon-si (KR)

Correspondence Address: Robert E. Bushnell, Suite 300, 1522 K Street, N.W., Washington, DC, 20005, US

(21) Appl. No.: 11/647,417

(22) Filed: Dec. 29, 2006

(30) Foreign Application Priority Data
Dec. 30, 2005 (KR) 10-2005-0135864

(51) Int. Cl. H01J 17/49

(52) U.S. Cl. 313/582; 313/586; 313/583

(57) ABSTRACT

Provided is a plasma display panel in which a dielectric layer is formed on a substrate on which electrodes are formed by a sheet lamination process. The plasma display panel includes a substrate, electrodes arranged on the substrate; and a dielectric layer disposed in a sheet form on the substrate on which the electrodes are arranged. The thickness ratio between the electrodes and the dielectric layer is in a range between 1:3.0 and 1:4.5.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on 30 Dec. 2005 and there duly assigned Serial No. 10-2005-0135864.

### BACKGROUND OF THE INVENTION

1. Field of the Invention

The present invention relates to a plasma display panel, and more particularly, to a plasma display panel in which a dielectric layer is formed on a substrate on which electrodes are formed using a sheet lamination process.

2. Description of the Related Art

Plasma display panels that recently receive attention as a replacement for contemporary cathode ray tubes are apparatuses that display video images using the light emitted from excited phosphor materials formed in a set pattern in discharge cells. The phosphor materials are excited by ultraviolet rays generated from a discharge gas sealed between two substrates on which a plurality of electrodes are formed when a discharge voltage is applied to the electrodes.

A contemporary plasma display panel is constructed with an upper plate and a lower plate coupled parallel to the upper plate. Sustain electrode are disposed on a front substrate of the upper plate. Address electrodes are formed to cross the sustain electrodes that are disposed on the front substrate, on a rear substrate of the lower plate that faces the front substrate.

A first dielectric layer and a second dielectric layer that respectively bury sustain electrodes and the address electrodes are respectively formed on the surface of the front substrate on which the sustain electrodes are formed and the surface of the rear substrate on which the address electrodes are formed.

The second dielectric layer can be formed by a printing method. As the plasma display panel becomes larger, a multi-cutting process is introduced, and in order to form a dielectric layer, a sheet lamination process is often used instead of the contemporary printing method.

In the case of the sheet lamination process, the dielectric, however, has a flowability lower than a paste of the printing method. Therefore, the burying characteristic of electrodes in the sheet lamination process is poorer than that in the printing method. That is, when laminating the dielectric, gaps between the electrodes or edge curls of the electrodes are not completely filled with the dielectric, and thus, pores can be generated during a subsequent firing process.

Due to the generation of pores, a withstand voltage of a dielectric layer of a plasma display panel may be undesirably reduced.

### SUMMARY OF THE INVENTION

It is therefore an object of the present invention to provide an improved plasma display panel.

It is another object to provide a plasma display panel in which, when a dielectric layer is formed using a sheet lamination process on a substrate on which electrodes are formed, the thickness ratio between the electrodes and the dielectric layer is controlled to provide withstand voltage characteristics above acceptable levels.

According to an aspect of the present invention, a plasma display panel is provided with a substrate, electrodes arranged on the substrate, and a dielectric layer disposed in a sheet form on the substrate on which the electrodes are arranged. The thickness ratio between the electrodes and the dielectric layer is in a range between 1:3.0 and 1:4.5.

The substrate may be a rear substrate, the electrodes may be address electrodes arranged on the rear substrate in a direction, and the dielectric layer may be a rear dielectric layer disposed on the address electrodes and the rear substrate.

The substrate may be a front substrate, the electrodes may be sustain electrode pairs arranged on the front substrate in a direction, and the dielectric layer may be a front dielectric layer disposed on the sustain electrode pairs and the front substrate.

According to another aspect of the present invention, a plasma display panel is provide with a first substrate and a second substrate facing each other, a plurality of barrier ribs that define a plurality of discharge cells between the first and second substrates, a plurality of sustain electrode pairs disposed on the first substrate, extending in a direction crossing the discharge cells, a plurality of address electrodes crossing the sustain electrode pairs, a first dielectric layer covering the sustain electrode pairs, a second dielectric layer that covers the address electrodes, and phosphor layers formed in the discharge cells. The thickness ratio between the address electrodes and the second dielectric layer is in a range between 1:3.0 and 1:4.5.

The second dielectric layer may be disposed in a sheet form on the second substrate and the address electrodes.

According to another aspect of the present invention, a plasma display panel is provided with a first substrate and a second substrate facing each other, a plurality of barrier ribs that define a plurality of discharge cells between the first and second substrates, a plurality of sustain electrode pairs disposed on the first substrate, extending in a direction crossing the discharge cells, a plurality of address electrodes crossing the sustain electrode pairs, a first dielectric layer covering the sustain electrode pairs, a second dielectric layer covering the address electrodes, and phosphor layers formed in the discharge cells. The thickness ratio between the sustain electrode pairs and the first dielectric layer is in a range between 1:3.0 and 1:4.5.

The first dielectric layer may be disposed in a sheet form on the first substrate and the sustain electrode pairs.

According to the present invention, when a dielectric layer is formed using a sheet lamination process on a substrate on which electrodes are formed, a plasma display panel has withstand voltage characteristics and discharge characteristics above acceptable levels.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective view illustrating a plasma display panel constructed as an embodiment of the principles of the present invention;

FIG. 2 is a cross-sectional view taken along line II-II according to an embodiment of the principles of the present invention of FIG. 1;

FIG. 3 is a graph showing the variation of withstand voltage of a plasma display panel according to the thickness ratio between address electrodes and a rear dielectric layer; and

FIG. 4 is a graph showing the variation of discharge firing voltage of a plasma display panel according to the thickness ratio between address electrodes and a rear dielectric layer.

### DETAILED DESCRIPTION OF THE INVENTION

The present invention will now be described more fully with reference to the accompanying drawings in which exemplary embodiments of the invention are shown.

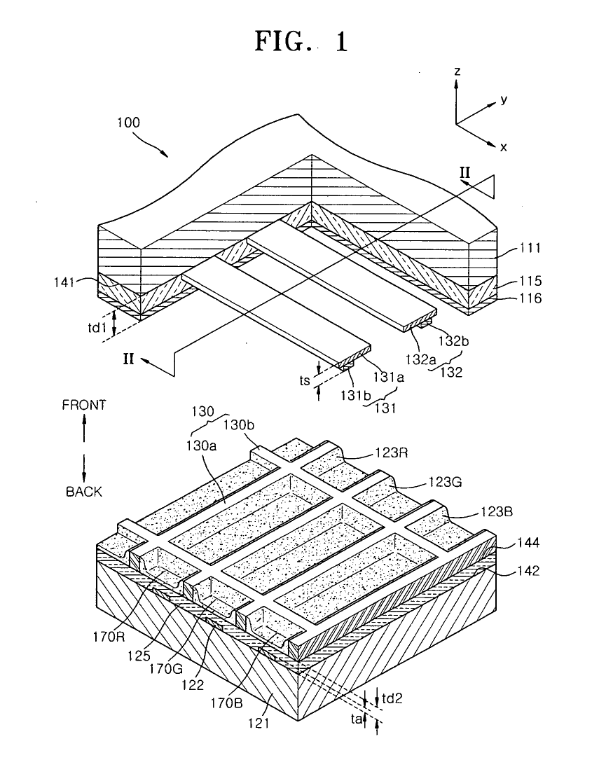

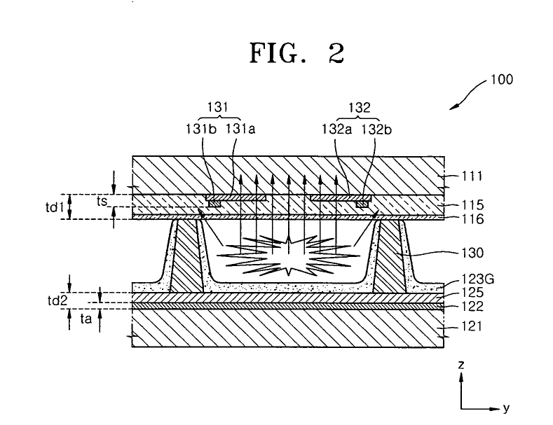

FIG. 1 is a cutaway exploded perspective view illustrating a plasma display panel 100 constructed as an embodiment of the principles of the present invention. FIG. 2 is a cross-sectional view taken along line II-Il of FIG. 1.

Referring to drawings, the alternating current type plasma display panel 100 is constructed with a first substrate 111, a second substrate 121, sustain electrode pairs 131 and 132, address electrodes 122, barrier ribs 130, a protective layer 116, phosphor layers 123R, 123G, and 123B, a first dielectric layer 115, a second dielectric layer 125, and a discharge gas (not shown).

First substrate 111 can be a front substrate, second substrate 121 can be a rear substrate, first dielectric layer 115 can be a front dielectric layer, and second dielectric layer 125 can be a rear dielectric layer.

Front substrate 111 and rear substrate 121 are spaced apart from each other and define a discharge space in which discharges are generated. Front and rear substrates 111 and 121 may be made from a material such as glass that has high transmittance of visible light. Front and/or rear substrates 111 and 121, however, can be colored to increase bright room contrast.

Barrier ribs 130 are disposed between front and rear substrates 111 and 121, and barrier ribs 130 can be disposed on second dielectric layer 125 according to a manufacturing process. Barrier ribs 130 define the discharge space into a plurality of discharge cells 170R, 170G, and 170B, and prevent optical and electrical cross-talk between discharge cells 170R, 170G, and 170B. In FIG. 1, barrier ribs 130 define discharge cells 170R, 170G, and 170B in a matrix arrangement having a rectangular horizontal cross-section, but the present invention is not limited thereto. That is, the horizontal cross-section of discharge cells 170R, 170G, and 170B can be a polygon such as a triangle or pentagon, or a circle or an oval, or can be an open type such as a strip. Also, discharge cells 170R, 170G, and 170B can be arranged to a waffle or delta shape.

Sustain electrode pairs 131 and 132 are disposed on rear surface 141 of front substrate 111 facing rear substrate 121. Each of the sustain electrode pairs is a pair of sustain electrodes 131 and 132 formed on rear surface 141 of front substrate 111 to generate sustain discharges, and sustain electrode pairs 131 and 132 are arranged parallel to each other on front substrate 111.

One of sustain electrode pairs 131 and 132 is an X electrode 131 that can be a common electrode, and the other one of sustain electrode pairs 131 and 132 is a Y electrode 132 that can be a scan electrode. Alternatively, X electrode 131 can be a scan electrode and Y electrode 132 can be a common electrode. In the current embodiment, sustain electrode pairs 131 and 132 are disposed on front substrate 111, but the present invention is not limited thereto. For example, sustain electrode pairs 131 and 132 can be disposed at a set distance apart from front substrate 111 in a direction toward rear substrate 121.

X and Y electrodes 131 and 132 respectively include transparent electrodes 131a and 132a and bus electrodes 131b and 132b. Optically transparent electrodes 131a and 132a are made from an electrically conductive transparent material that does not interrupt the progress of light emitted from phosphor layers 123R, 123G, and 123B, such as ITO.

When sustain electrode pairs 131 and 132 are only made from ITO, however, power consumption is high and response speed is slow due to a large voltage drop in a longitudinal direction of sustain electrodes 131 and 132. Accordingly, to reduce the power consumption, bus electrodes 131b and 132b made from a metal having a narrow width can be disposed on transparent electrodes 131a and 132a. Bus electrodes 131b and 132b can be formed as a single layer structure using Ag, Al, or Cu, and can also be formed as a multiple layer structure using Cr/Al/Cr. Transparent electrodes 131a and 132a and bus electrodes 131b and 132b can be formed using a photoetching method or a photolithography method.

The shapes and locations of X electrode 131 and Y electrode 132 will be described in detail. Bus electrodes 131b and 132b are disposed parallel to each other in a unit discharge cell and extend continuously across discharge cells 170R, 170G, and 170B. As described above, transparent electrodes 131a and 132a respectively electrically contact bus electrodes 131b and 132b, and the rectangular shaped transparent electrodes 131a and 132a can be discontinuously disposed in each unit discharge cell.

First dielectric layer 115 covering sustain electrode pairs 131 and 132 is formed on front substrate 111. First dielectric layer 115 prevents X electrode 131 and Y electrode 132 from electrically connecting to each other, and also prevents X electrode 131 and Y electrode 132 from being damaged by directly colliding with charged particles or electrons. Also, first dielectric layer 115 functions to induce charges. First dielectric layer 115 is made from a dielectric such as PbO, B₂O₃, or SiO₂.

Plasma display panel 100 may be further constructed with protective layer 116 covering first dielectric layer 115. Protective layer 116 prevents first dielectric layer 115 from being damaged by colliding with charged particles and electrons during discharge.

Also, protective layer 116 facilitates the plasma discharge by emitting a lot of secondary electrons during discharge. Protective layer 116 having the above functions is made from a material having high secondary electron emission coefficient and high visible light transmittance. Protective layer 116 is formed as a thin film mainly using sputtering or electron beam deposition after first dielectric layer 115 is formed.

Address electrodes 122 are formed on surface 142 of rear substrate 121 facing front substrate 111. Address electrodes 122 extend across discharge cells 170R, 170G, and 170B so as to cross X electrodes 131 and Y electrodes 132.

Address electrodes 122 are formed to generate an address discharge that facilitates the generation of a sustain discharge between X and Y electrodes 131 and 132. More specifically, address electrodes 122 function to reduce a firing voltage for generating the sustain discharge. When the address discharge is generated between Y electrode 132 and address electrode 122, and when the address discharge is over, wall charges are accumulated on X electrode 131 and Y electrode 132, and thus, the wall charges facilitate the generation of the sustain discharge between X and Y electrodes 131 and 132.

Spaces formed by a pair of X and Y electrodes 131 and 132 and address electrodes 122 that cross X and Y electrodes 131 and 132 are discharge cells 170R, 170G, and 170B.

Second dielectric layer 125 covering address electrodes 122 is formed on rear substrate 121. Second dielectric layer 125 is made from a dielectric that can prevent address electrodes 122 from being damaged by colliding with charged particles or electrons during discharges and can induce charges, such as PbO, B₂O₃, or SiO₂.

Phosphor layers 123R, 123G, and 123B of red, green, and blue colors are disposed on the sidewalls of barrier ribs 130 on second dielectric layer 125 and front surface 144 of second dielectric layer 125 on which barrier ribs 130 are not formed. Phosphor layers 123R, 123G, and 123B include a component that emits visible light by receiving ultraviolet rays. Phosphor layer 123R formed in the red light emitting cell includes a phosphor material such as Y(V,P)O₄:Eu, phosphor layer 123G formed in the green light emitting cell includes a phosphor material such as Zn₂SiO₄:Mn or YBO₃:Tb, and phosphor layer 123B formed in the blue light emitting cell includes a phosphor material such as BAM:Eu.

A discharge gas made of a mixture of Ne gas and Xe gas is filled in discharge cells 170R, 170G, and 170B, and while the discharge gas is filled in discharge cells 170R, 170G, and 170B formed between front substrate 111 and rear substrate 121. Front substrate 111 and rear substrate 121 are combined to each other and sealed using a sealing member (not shown) such as frit glass applied on the edges of front substrate 111 and rear substrate 121.

When a sustain discharge is generated, ultraviolet rays are emitted while the energy level of the excited discharge gas is reduced. The emitted ultraviolet rays simultaneously excite phosphor layers 123R, 123G, and 123B coated in discharge cells 170R, 170G, and 170B. Visible light is generated from excited phosphor layers 123R, 123G, and 123B while the energy level of phosphor layers 123R, 123G, and 123B is reduced. The visible light emitted through first dielectric layer 115 and front substrate 111 displays video images.

Due to the increase in size of plasma display panels and the use of a multi-cutting process, the size of substrates gradually increases. Accordingly, in order to form a dielectric layer on a large substrate, first dielectric layer 115 and/or second dielectric layer 125 may be formed using a sheet lamination process.

According to the sheet lamination process, electrodes are formed on a substrate, a dielectric layer is formed as a sheet on the substrate on which the electrodes are formed, and is subsequently baked. The dielectric sheet on the substrate is pressed by a press roller.

When a dielectric layer is formed using such a sheet lamination process as described above, the flowability of the lamination sheet is smaller than the flowability of a paste used in a printing process. In particular, in order to form each of first dielectric layer 115 and second dielectric layer 125, since a dielectric layer must be formed on sustain electrode pairs 131 and 132 or address electrodes 122, it is difficult for the lamination sheet to tightly contact gaps between the electrodes or edge curls of the electrodes. Therefore, pores can be generated during the subsequent firing, which deteriorate the withstand voltage characteristics and discharge characteristics.

Accordingly, in the current embodiment of the principles of the present invention, the thickness ratio between the electrodes and the dielectric layer is limited to a range from 1:3.0 to 1:4.5 to increase the withstand voltage characteristics and the discharge characteristics.

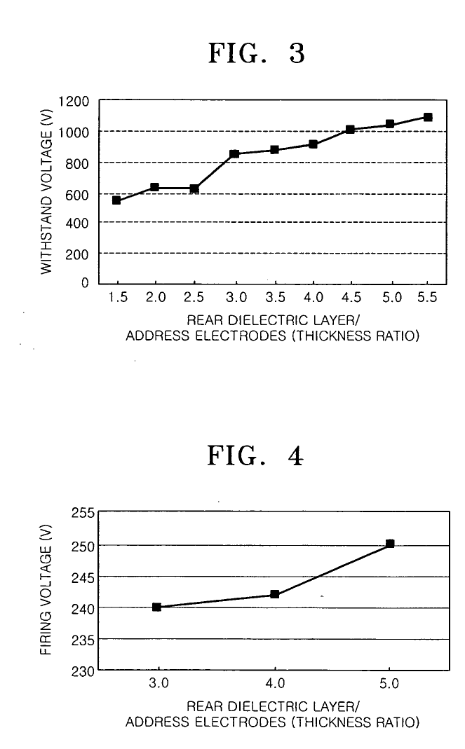

FIGS. 3 and 4 are graphs respectively showing the variations of an withstand voltage and a firing voltage of a plasma display panel 100 according to thickness ratio td2/ta between rear dielectric layer 125 and address electrodes 122.

Referring to FIGS. 3 and 4, when thickness ratio td2/ta is smaller than 3.0, the firing voltage can be reduced to 240 V or less, but the withstand voltage can be reduced to approximately 700 V or less. When the thickness ratio td2/ta is higher than 4.5, the withstand voltage can be increased to approximately 1000 V or higher, but the firing voltage can be increased to 250 V or higher. Accordingly, in the current embodiment, the thickness ratio td2/ta between second dielectric layer 125 and address electrodes 122 may be in a range from 3.0 to 4.5, and in this range, the withstand voltage can be greater than 800V and the firing voltage can be smaller than 250V.

To meet the above requirement, if firing height ta of address electrodes 122 is 4 μm, firing height td2 of second dielectric layer 125 may be 12 to 18 μm. At this time, when firing height td2 of second dielectric layer 125 is lower than 12 μm, the firing voltage can be reduced, but there is a problem of reducing the withstand voltage below 600V. Also, when firing height td2 of second dielectric layer 125 is higher than 18 μm, the withstand voltage characteristics can be improved, but the firing voltage can be increased to 250V or more, thereby reducing the discharge characteristics.

The formation of a dielectric layer using the sheet lamination process can also be applied to the formation of first dielectric layer 115. Therefore, the limitation of the thickness ratio between address electrodes 122 and second dielectric layer 125 can be applied to the thickness ratio td1/ts between first dielectric layer 115 and sustain electrode pairs 131 and 132.

According to the present invention, when a dielectric layer is formed on a substrate on which electrodes are formed using a sheet lamination process, a plasma display panel has a withstand voltage characteristics and discharge characteristics greater than an appropriate level.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel, comprising:
a substrate;
electrodes arranged on the substrate; and
a dielectric layer disposed in a sheet form on the substrate on which the electrodes are arranged,
wherein the thickness ratio between the electrodes and the dielectric layer is in a range between 1:3.0 and 1:4.5.

2. The plasma display panel of claim 1, with:
the substrate being a rear substrate;
the electrodes being address electrodes arranged on the rear substrate in a direction; and
the dielectric layer being a rear dielectric layer disposed on the address electrodes and the rear substrate.

3. The plasma display panel of claim 1, with:
the substrate being a front substrate;
the electrodes being sustain electrode pairs arranged on the front substrate in a direction; and
the dielectric layer being a front dielectric layer disposed on the sustain electrode pairs and the front substrate.

4. A plasma display panel, comprising:
a first substrate and a second substrate facing each other;
a plurality of barrier ribs defining a plurality of discharge cells between the first and second substrates;
a plurality of sustain electrode pairs disposed on the first substrate, extending in a direction crossing the discharge cells;
a plurality of address electrodes crossing the sustain electrode pairs;
a first dielectric layer covering the sustain electrode pairs;
a second dielectric layer covering the address electrodes; and
phosphor layers formed in the discharge cells, with the thickness ratio between the address electrodes and the second dielectric layer is in a range between 1:3.0 and 1:4.5.

5. The plasma display panel of claim 4, with the second dielectric layer being disposed in a sheet form on the second substrate and the address electrodes.

6. A plasma display panel, comprising:
a first substrate and a second substrate facing each other;
a plurality of barrier ribs defining a plurality of discharge cells between the first and second substrates;
a plurality of sustain electrode pairs disposed on the first substrate, extending in a direction crossing the discharge cells;
a plurality of address electrodes crossing the sustain electrode pairs;
a first dielectric layer covering the sustain electrode pairs;
a second dielectric layer covering the address electrodes; and
phosphor layers formed in the discharge cells, with the thickness ratio between the sustain electrode pairs and the first dielectric layer being in a range between 1:3.0 and 1:4.5.

7. The plasma display panel of claim 6, with the first dielectric layer being disposed in sheet form on the first substrate and the sustain electrode pairs.
